(19) United States
(12) Patent Application Publication
(10) Pub. No.: US 2015/0285049 A1
(43) Pub. Date: Oct. 8, 2015

(54) Method of Drilling for and Producing Oil and Gas from Earth Boreholes

(71) Applicant: Maximo Tejeda, Houston, TX (US)

(72) Inventor: Maximo Tejeda, Houston, TX (US)

(21) Appl. No.: 14/680,638

(22) Filed: Apr. 7, 2015

Related U.S. Application Data
(60) Provisional application No. 61/976,048, filed on Apr. 7, 2014.

(51) Int. Cl. E21B 43/24; E21B 21/16; C09K 8/80; C09K 8/02; C09K 8/58; E21B 43/267; E21B 43/114

(52) U.S. Cl. CPC E21B 43/2405; E21B 43/267; E21B 21/16; E21B 43/114; C09K 8/02; C09K 8/58; C09K 8/80; E21B 2021/006

(57) ABSTRACT

A method of recovering hydrocarbons from shale formations wherein a borehole is drilled under underbalanced conditions into a hydrocarbon-containing formation and, following fracturing with a cryogenic liquid, hydrocarbons released from the fractured formation are produced and recovered.

### CROSS REFERENCE TO RELATED APPLICATION

This application claims priority to U.S. Application No. 61/976,048 filed on Apr. 7, 2014, the disclosure of which is incorporated herein by reference for all purposes.

### FIELD OF THE INVENTION

The present invention relates to the drilling of oil and/or gas wells and the production and recovery of oil and gas therefrom.

### BACKGROUND OF THE INVENTION

Over the last several years there has been a dramatic increase in the production of oil and/or gas from shale formations scattered in many areas throughout the United States. Indeed, production of oil and gas in the United States is on track to make the United States energy independent and perhaps even a net exporter of oil and gas. As used herein, the word “shale” refers to any rock of fissile or laminated structure formed by the consolidation or compaction of clay or argillaceous material, as well as coal seams, sandstone, mudrock and similar material which contain hydrocarbons, particularly gaseous and liquid hydrocarbons.

The dramatic increase in the production of oil and gas in the United States can be largely traced to the development of technology for tapping the oil and gas trapped in tight shale formations. In particular, the use of horizontal or lateral drilling of boreholes coupled with hydraulic fracturing has opened vast formations/reservoirs of oil and gas which were once considered inaccessible. However, the success in recovering hydrocarbons from these tight shale formations has produced a new set of challenges for the oil and gas industry.

For example, in the case of hydraulic fracturing, there are growing concerns that chemicals used in the fracturing fluids, commonly referred to as frac fluids, can leach into underground aquifers and water supplies.

The chemicals in frac fluids can include friction reducers, surfactants, corrosion inhibitors, biocides, stabilizers, and lubricants to name a few which perform a number of functions aimed at preventing build up in the wellbore to facilitate transfer of the gas/oil from the formation to the producing well.

As is well known, fracturing fluids also contain a proppant, generally sand, to prop open the fissures created in the shale formation to allow for free flow of hydrocarbons from the formation. In general, proppants should be permeable or permittive to gas under high pressures, the interstitial space between particles should be sufficiently large yet have the mechanical strength to withstand closure stresses to hold fractures open after the fracturing process is completed. It is well known that large mesh proppants possess greater permeability at low closure stresses but will mechanically fail, e.g., be crushed, and produce very fine particulates at high closure stresses such that smaller mesh proppants overtake larger mesh proppants an permeability after a certain threshold stress. Thus, although sand is a common proppant, it is subject to the formation of significant fines which in turn can block the fissures curtailing the free flow of hydrocarbons from the formation and leaving significant amounts of hydrocarbons trapped in the fractured formations.

A compounding problem, whether real or perceived, is that large amounts of the frac fluid can remain underground increasing the probability that the chemicals from the frac fluid will continue to leak into the aquifers.

Over and above the rising concerns of the use of frac fluids and hydraulic fracturing in general, there are also escalating concerns that the drilling fluids used to drill the wells contain chemical additives which serve certain functions in the drilling process and again which are deemed by a rising number of critics as a further source of underground water contamination.

Another important problem using conventional drilling techniques coupled with hydraulic fracturing is the use of vast amounts of water. This poses a particular problem in areas of the United States which are arid but which may contain large shale deposits rich in recoverable hydrocarbons. In these areas, there is clear tension between using the water to recover hydrocarbons by conventional drilling/fracturing techniques, and preserving the water for agricultural and household use. These concerns over drilling and fracturing have resulted in certain states severely curtailing the development of these underground tight shale formations.

Fracturing with extremely cold fluids has also been used. Thus, liquefied gases such as liquefied low carbon number hydrocarbons, e.g., methane, natural gas, and liquid nitrogen, have been employed to conduct formation fracturing via the mechanism of inducing thermal tensile stresses in the face of the formation. It is well known that such stresses can exceed the tensile strength of the shale causing the fracture face to fragment.

There is a clear need for a method of drilling into shale formations and recovering hydrocarbons from such formations which can overcome many of the concerns discussed above. Indeed, given the importance to the United States economy and security of being energy self-sufficient, and until alternative, non-fossil sources of fuel are developed to the point where they are commercially viable, it is important that the vast amounts of hydrocarbons, not only in tight shale formations, but in other formations as well, be recovered in a manner which maximizes hydrocarbon recovery while minimizing environmental damage.

Underbalanced drilling (UBD) was first used in the 1800's. Because of difficulties encountered in UBD, growth of the technique through the 1970's was limited. Elimination of the problems that historically plagued UBD technology and the introduction of horizontal drilling in the 1980's caused a rapid expansion in the number of underbalanced wells drilled worldwide. An in depth discussion of UBD, methods, drilling fluid systems, and equipment used in UBD, is set forth in STEVE NAS, Petroleum Engineering Handbook, 2006, Ch. 12, pgs. 519-569, Vol. II, incorporated herein by reference for all purposes.

One of the primary advantages of UBD is the reduction in formation damage in reservoirs where overbalanced drilling, e.g., drilling with conventional drilling mud, would reduce production due to skin damage. The latter is caused by a number of factors, including solids invasion, phase trapping, clay swelling, and emulsification. While the main advantage of UBD is from the reduction of reservoir damage, UBD also provides advantages of increased rate of penetration, reduction of loss circulation, and differential sticking. In this regard, it should be noted that the latter is perhaps the greatest drilling problem worldwide because of the time and money spent to correct the problem. UBD also can result in the reduction in use of potentially harmful chemicals or additives presently used in many conventional drilling fluids.

### SUMMARY OF THE INVENTION

In one aspect, the present invention provides a method for the recovery of hydrocarbons from formations in which the hydrocarbons are tightly held.

In another aspect, the present invention provides a method of recovering hydrocarbons which is environmentally friendly.

In yet another aspect, the present invention provides a method of recovering hydrocarbons from underground formations in which the hydrocarbons are tightly bound, and which can increase the volume of production of the hydrocarbons from the formation.

These and further features and advantages of the present invention will become apparent from the following detailed description, wherein reference is made to the figures in the accompanying drawings.

### DETAILED DESCRIPTION OF PREFERRED EMBODIMENTS

The method of the present invention involves two primary phases (1) the drilling of a borehole into a desired formation, and (2) production of hydrocarbons from the drilled formation.

While the invention will be described with particular reference to the recovery of hydrocarbons from tight shale formations, it will be understood that it is not so limited and can be used for drilling in other types of formations.

The term “environmentally friendly,” “eco-friendly,” or similar terms, refer to a liquid which is substantially biodegradable and/or capable of achieving 96 hour LC₅₀ Mysid shrimp (Mysidopsis bahia) bioassay test results greater than 100,00 ppm. A fluid free of aromatic hydrocarbons is particularly desirable.

Drilling the Borehole

The method of the present invention utilizes formation of the borehole by UBD. In the UBD according to the present invention, the wellhead equipment can comprise a rotating head, a pumping assembly for introducing the drilling fluid into the wellbore, a solids separation train to separate drill cuttings from the drilling fluid as well as various valves and other well known equipment. It will be understood that the borehole can be drilled using conventional drill pipe or coiled tubing. In either event, the drill string is generally provided with a drilling motor, drill bit, and measurement-while-drilling (MWD) equipment when suitable.

The main methods of UBD are:
the use of lightweight drilling fluids,
the use of gas injection down through the drill string,
the use of gas injection through a parasite string,
the use of foam injection.

In the case of light weight drilling fluids, diesel or crude oil can be used. However, to provide the most environmentally friendly drilling fluid, mineral oil, or any number of synthetic or natural hydrocarbon liquids and other fluids, some commonly used in enhanced oil recovery (EOR) can be employed.

With respect to the use of gas injection through the drill string, air or nitrogen is used and is pumped directly down the drill string.

In the case of injection of gas via a parasite string, a second pipe is run outside of the intermediate casing. The disadvantages of this technique are the additional costs and time as well as the need for larger diameter surface casing.

Lastly, in the case of foam as the drilling fluid, the foam generally comprises a liquid dispersion in which the liquid is a continuous phase and the gas is the discontinuous phase. A disadvantage of the use of foam is that it exhibits some sensitivity to hydrocarbons and can be destabilized by hydrocarbon production from the drilled formation.

In general, in the drilling aspect of the present invention, it is preferred to use a lightweight drilling fluid, and more particularly, one of the fluids described in the above incorporated references, particularly one that is environmentally friendly or safe. Nonlimiting examples of suitable drilling fluids for use in the UBD method of the present invention are disclosed in WO 2014/047600; U.S. Pat. No. 6,159,907; and the patents and publications cited and listed therein, all of which are incorporated herein by reference for all purposes. Other synthetic fluids such as linear alpha olefins, isomerized olefins, polyalpha olefins, and esters, can also be used as drilling fluid in the UBD method of the present invention. It is preferred to use a drilling fluid which is environmentally safe. The above-listed references and patents list many such environmentally safe fluids that can be used as drilling fluids in the method of the present invention. In particular, a hydrocarbon fluid as described in WO 2014/047600 is particularly desirable. It will be understood that the drilling fluid chosen can be tailored, as per methods, well known to those skilled in the art, to have the desired weight vis-à-vis exerting hydrostatic pressure in the borehole which is not greater than the formation pressure. Thus, glass beads, plastic beads, composite beads, and other such materials can be added to the drilling fluid to decrease its weight such that the drilling fluid remains in an underbalanced, or at the very least, near balanced condition.

It will be understood that according to one aspect of the present invention, the borehole contains a vertical run and a lateral run, the lateral run extending generally horizontally into a seam of a hydrocarbon bearing formation. This does not exclude the use of multi-lateral wellbore configurations, including but not restricted to, vertical staggered laterals as well as horizontally spread laterals, in various shapes and forms. The aim is to increase the conducting surface within the same zone, by creating a dense network of intersecting fractures and at the same time target multiple pay zones.

It will be understood that following the drilling operation, and even though most of the drill cuttings have been returned to the surface during the drilling operation and separated from the drilling fluid, there may remain drill cutting fines, particularly along the low side of the horizontal leg. These fines have the potential to plug the formation and act much in the nature of a filter cake which typically forms in conventional drilling operations. This obviously will result in reduced production of hydrocarbons from the fractured formation.

According to another unique aspect of the present invention, once the drilling operation has ceased, the wellbore can be flushed with a gas such as air or nitrogen to carry the residual drill cutting fines out of the borehole and to the surface. At this point, since the borehole has been drilled into a tight shale formation, it is anticipated that little hydrocarbon production will have occurred. Thus, according to the method of the present invention, there will be an essentially clean borehole comprising a cased vertical leg and an open hole horizontal or lateral leg.

Hydrocarbon Production from the Formation

As described above, because the shale formations bind the hydrocarbons so tightly, they do not freely flow from the formation into borehole for production. To this end, and again as discussed above, hydraulic fracturing has typically been employed to cause fissures in the formation and allow the free flow of hydrocarbons from the formation into the borehole for production.

In one aspect, according to a next stage of operation of the method of the present invention, the open hole section can be perforated by the use of suitable perforating guns and shaped charges. Commonly, perforating guns are run on an E-line as it is traditional to use electrical signals from the surface to fire the guns. However, in more highly deviated wells of the type under consideration with respect to the present invention, coil tubing may be used. Furthermore, modern slickline technology using embedded fiber optic lines that can transmit two-way data on real-time temperature, pressure, and seismic responses along the length of the slickline can be used. This information allows very precise operation of various downhole tools, including perforating guns. Clearly the benefit of the latter strategy is greater control of the well.

As is well known to those skilled in the art, one disadvantage of perforating in conventional wells is that it can lead to “skin damage” wherein debris from perforations can hinder productivity of the well. However, since in this case the perforation is conducted under underbalanced conditions, the higher formation pressure will cause hydrocarbon fluids to flow into and out of the perforations, carrying the debris out of the perforations.

In the production method of the present invention, it is desirable that the perforating be carried out with the largest, most powerful guns available. Many different types of perforating guns can be employed such as hollow-carrier guns, strip-type capsule guns, and link-type capsule guns. Whatever the type of perforating equipment employed, the goal is to achieve deep, as well as, large diameter perforations to facilitate the subsequent fracturing operation.

Once the perforating operation has been completed, it may again be desirable to sweep the hole with air or nitrogen to remove as much debris as possible resulting from the perforations.

In one aspect, in a next phase of the operation of the method of the present invention, a cryogenic liquid such as liquid nitrogen, argon, liquefied natural gas, C₁-C₄ hydrocarbons, etc. is employed to conduct the hydraulic fracturing. The temperature of liquid nitrogen is from about −320° F. to about −300° F. Introduction of the liquid nitrogen into the perforated wellbore induces thermal stresses in the facture. These are enhanced by the resulting freezing and expansion of trapped water in the formation. As well, the liquid nitrogen will also flow into the perforations, maximizing the amount of the producing formation which is subjected to the thermal shock induced by the liquid nitrogen. Further, subsequent vaporization of liquid nitrogen will result in high pressure which aids in the fracturing.

The liquid nitrogen, depending upon the depth of the well, can be introduced through vacuum insulated tubing (VIT) to ensure minimal heat loss. Such an assembly must be made of materials which can withstand the extremely cold temperatures without failing. In lieu of VIT, specially constructed coil tubing e.g., composites, can also be used to introduce the liquid nitrogen.

As is well known to those skilled in the art, conventional hydraulic fracturing is conducted in stages along the length of the borehole in the producing formation. In like manner, the liquid nitrogen fracturing employed in the method of the present invention is also conducted in stages which are typically separated from one another by packer/valve bridges.

Although as described above, the cryogenic liquid fracturing is conducted after the perforating stage, it will be understood that it may be desirable to again perforate after the liquid nitrogen has been introduced. At this stage, since the formation is at extremely cold temperatures and quite brittle, this additional perforating step can lead to a greater degree of fracturing forming more fissures and enhancing the number of pathways for free flow of hydrocarbons from the formation into the borehole.

The method of the present invention also contemplates pressuring the fractured formation using a high pressure liquid such as for example a compressed, pressurized C₁-C₁₀ hydrocarbon such as described above for use in the drilling operation.

Specialized proppants can be used to keep the fissures caused by the fracturing open and to allow free flow of the hydrocarbons from the formation. Although as noted above sand is a common proppant in conventional hydraulic fracturing, it is also known that sand at such cold temperatures can sinter into fines and result in plugging or at least reduced flow of hydrocarbons from the formation. Accordingly, the preferred proppants are those which are resistant to thermal shock and can include by way of example, carbon, graphite, as well as certain engineered ceramics and composites.

Once the formation has been fractured, hydrocarbon production can commence, the hydrocarbons being recovered at the surface by methods well known to those skilled in the art.

As can be seen from the above description, the method of the present invention provides a number of distinct advantages over the current technology for the drilling and producing of hydrocarbons from tight shale formations. In this regard, in the drilling phase of the method, the drilling fluid selected can be quite environmentally friendly, reducing fear of introduction of harmful chemicals into aquifers and other underground water sources. Likewise, the absence of chemicals in the fluid used for the fracturing also minimizes the threat of underground water contamination. Further, since little or no water may be used in the method of the present invention, the method of the present invention is adaptable to the recovery of hydrocarbons from formations in areas where water is scarce. In this regard, it should be noted that the method of the present invention can be conducted with a substantially water-free drilling fluid or mud as well as a water-free fracturing fluid.

Another distinct advantage of the method of the present invention is that the footprint of the well site is greatly reduced as compared with well sites wherein conventional drilling and fracturing are being conducted. Again, this alleviates environmental concerns associated with conventional drilling and fracturing.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A method of producing hydrocarbons from an underground hydrocarbon-containing formation, comprising:
drilling an earth borehole into a subterranean hydrocarbon-containing formation under underbalanced drilling conditions;
introducing a cryogenic liquid into at least a portion of said earth borehole in contact with said formation;
allowing said cryogenic liquid to create fissures in said formation by inducing thermal shock into said formation;
introducing a proppant into said formation to hold open said fissures; and
recovering released hydrocarbons from said formation.

2. The method of claim 1, wherein said earth borehole comprises a generally vertical section and a substantially horizontal section extending into said formation.

3. The method of claim 1, wherein said underbalanced drilling utilizes a drilling fluid comprising a hydrocarbon liquid.

4. The method of claim 3, wherein said hydrocarbon liquid is environmentally friendly.

5. The method of claim 3, wherein said drilling fluid comprises a material to lighten the weight of said fluid.

6. The method of claim 5, wherein said material comprises plastic beads.

7. The method of claim 1, further comprising sweeping said earth borehole with a sweep fluid after said earth borehole is drilled.

8. The method of claim 7, wherein said sweep fluid comprises a gas.

9. The method of claim 1, further comprising perforating said formation prior to introducing said cryogenic liquid.

10. The method of claim 9, comprising further perforating said formation after introducing said cryogenic liquid.

11. The method of claim 1, wherein said cryogenic fluid is selected from the group consisting of nitrogen, argon, C₁-C₄ hydrocarbons, and mixtures thereof.

12. The method of claim 11, wherein said cryogenic fluid comprises nitrogen.

13. The method of claim 1, further comprising pressurizing said formation with a nonaqueous fluid after said cryogenic fluid has been introduced to induce further fissures in said formation.

14. The method of claim 13, wherein said nonaqueous fluid comprises a hydrocarbon having from 1 to 10 carbon atoms.
